(19) United States
(12) Patent Application Publication
(10) Pub. No.: US 2006/0247378 A1
(43) Pub. Date: Nov. 2, 2006

(54) Thermoplastic elastomer blend, method of manufacture and use thereof

(76) Inventor: Hari Babu Sunkara, Hockessin (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/215,407

(22) Filed: Aug. 30, 2005

Related U.S. Application Data
(60) Provisional application No. 60/676,836, filed on May 2, 2005.

(51) Int. Cl. C08L 77/00

(52) U.S. Cl. 525/178

(57) ABSTRACT

A curable thermoplastic elastomeric composition comprising: (a) polyalkylene ether ester amide elastomer; (b) crosslinkable poly(meth)acrylate rubber; and (c) a crosslinking system to crosslink the rubber. A melt processible thermoplastic elastomeric composition comprising: (a) a continuous phase comprising polyalkylene ether ester amide elastomer; and (b) crosslinked poly(meth)acrylate rubber disperse phase. A process for manufacturing a melt processible thermoplastic elastomeric composition comprising the steps: (a) providing a cross-linkable poly(meth)acrylate rubber; (b) providing crosslinking system in an amount effective to crosslink the poly(meth)acrylate rubber; (c) providing polyalkylene ether ester amide elastomer; (d) forming a mixture of the cross-linkable poly(meth)acrylate rubber, the polyalkylene ether ester amide elastomer and the crosslinking system; (e) cross-linking the cross-linkable poly(meth)acrylate rubber in the mixture using the crosslinking system; and (f) recovering a melt processible thermoplastic elastomeric composition comprising the polyether ester elastomer as a continuous phase and the crosslinked poly(meth)acrylate rubber as a disperse phase. A shaped article (e.g., an extruded or molded article) made from a melt processible thermoplastic elastomeric composition comprising: (a) a continuous phase comprising polyalkylene ether ester amide elastomer, and (b) a disperse phase comprising cross-linked poly(meth)acrylate rubber. Preferably the shaped article is selected from the group consisting of hoses, gaskets, films, belts, cable jackets, seals, gears and bearings.

### PRIORITY

This application claims priority from Provisional U.S. Patent Application Ser. No. 60/676,836, filed May 2, 2005, incorporated herein by reference.

### FIELD OF THE INVENTION

The invention relates to melt processible thermoplastic elastomeric blends, their manufacture, and their use in shaped or molded rubber articles.

### BACKGROUND OF THE INVENTION

For many applications in the petroleum and automotive industries there is a need for elastomeric materials with good oil resistance at elevated temperatures. There is a particular need for materials that are flexible and soft (low in hardness) with good resistance to heat and compression set.

It is generally known in the art to employ curable polyacrylate elastomers to manufacture high performance rubber parts having excellent resistance to lubricating oils and greases which are therefore useful in selected automotive applications and the like. The gum rubber vulcanizates are either polyacrylate elastomers derived from copolymerization of acrylic acid ester monomers (e.g., ethyl, butyl, and methoxyethyl acrylate and can include some vinyl acetate), polyethylene/acrylate elastomer derived from copolymerization of ethylene monomer and acrylic acid ester monomers (e.g. ethylene and methyl acrylate and can include other comonomers and grafts, see for example U.S. Patent Publication No. 2002/0004568 A1 incorporated herein by reference), or polyperfluoroalkyl acrylate elastomer derived from polymerization of fluorinated acrylic ester monomer (e.g., 1,1 dihydroperfluoro-n-butyl acrylate). The polyacrylate elastomers also can be functionalized by incorporating a relatively small amount of an additional comonomer such as an acrylate glycidyl ester, maleic acid or other comonomer having a reactive group including acid, hydroxyl, epoxy, isocyanate, amine, oxazoline, chloroacetate or diene. These functionalized polyacrylate elastomers can then be cured using a curative co-agent containing functional groups that covalently bond to the functionalized reactive sites of the polyacrylate elastomer.

One problem associated with the prior art curable polyacrylate elastomers is the inherent rheological limitations of high viscosity and low melt flow of their cured or partially cured state. Consequently, physical blending followed by compression molding and subsequent curing is usually necessary to achieve acceptable properties rather than extrusion or injection molding directly to a finished part (as discussed above). However, in European Patent 0 337 976 B1 and in U.S. Pat. No. 4,981,908 thermoplastic elastomer compositions are disclosed comprising blends of polyester resin (including segmented polyether ester elastomers commercially available under the trademark HYTREL® (E.I. du Pont de Nemours and Company, Wilmington, Del. (“DuPont”)) and dynamically vulcanized, covalently cross-linked acrylate rubber (including ethylene/methyl acrylate terpolymer containing about one mole percent of a carboxylic acid containing comonomer, commercially available under the trademark VAMAC®. (DuPont). The covalent cross-linking in these disclosures is achieved by employing a functionalized polyacrylate elastomer in combination with reactive difunctional cross-linking agent. However, almost all of these difunctional cross-linking agents can also react with the ester units in the polyalkylene phthalates (i.e., an amine, hydroxyl or carboxylic acid group will exchange with the ester groups and epoxy or acid groups will add to the hydroxyl end groups), which leads to high viscosity and lack of reproducibility.

In U.S. Patent Application Publication No. 2004/0115450 there is disclosed a curable thermoplastic elastomeric blend comprising a polyalkylene phthalate polyester polymer or copolymer and a crosslinkable poly(meth)acrylate or ethylene/(meth)acrylate copolymer vulcanizate rubber in combination with a peroxide free-radical initiator and an organic multiolefinic coagent to crosslink the rubber during extrusion or injection molding of the blend.

Block polyether ester amide elastomers are well known and methods of making block polyether ester amide elastomers suitable for injection molding and melt spinning fibers are disclosed in U.S. Pat. Nos. 5,387,651 and 6,590,065. However, melt processible thermoplastic elastomeric blends from polyether ester amide elastomers are not known.

It is an objective of the present invention to provide flexible thermoplastic elastomeric blends which provide excellent resistance to thermal aging and good chemical resistance, to a process for making such elastomeric blends, and to shaped or molded articles made from such blends.

### SUMMARY OF THE INVENTION

It has now been found that curable thermoplastic elastomeric compositions can be made using block polyalkylene ether ester amide elastomer, cross-linkable poly(meth)acrylate rubber, and crosslinking system to crosslink the rubber. The curable thermoplastic compositions are amenable to dynamic crosslinking during the extrusion or injection molding of the starting components, resulting in a melt processible thermoplastic elastomeric compositions having a crosslinked poly(meth)acrylate rubber as the dispersed phase and polyalkylene ether ester amide elastomer as the continuous phase.

Thus, in one embodiment the present invention is a curable thermoplastic elastomeric composition comprising:

(a) polyalkylene ether ester amide;

(b) crosslinkable poly(meth)acrylate rubber; and

(c) a crosslinking system to crosslink the rubber.

The invention also provides a melt processible thermoplastic elastomeric composition comprising:

(a) a continuous phase comprising polyalkylene ether ester amide; and

(b) crosslinked poly(meth)acrylate rubber disperse phase.

The present invention also provides a process for manufacturing a melt processible thermoplastic elastomeric composition comprising the steps:

(a) providing a cross-linkable poly(meth)acrylate rubber;

(b) providing crosslinking system in an amount effective to crosslink the poly(meth)acrylate rubber;

(c) providing polyalkylene ether ester amide;

(d) forming a mixture of the cross-linkable poly(meth)acrylate rubber, the polyalkylene ether ester amide elastomer and the crosslinking system;

(e) cross-linking the cross-linkable poly(meth)acrylate rubber in the mixture using the crosslinking system; and

(f) recovering a melt processible thermoplastic elastomeric composition comprising the polyether ester elastomer as a continuous phase and the crosslinked poly(meth)acrylate rubber as a disperse phase.

Preferably the cross-linking is carried out during extrusion or injection molding of the melt processible thermoplastic elastomeric composition.

Preferably the mixing is carried out a temperate of about 80 to about 130° C. Preferably the crosslinking is carried out a temperate of about 180 to about 275° C.

In yet another embodiment the invention also provides a shaped article (e.g., an extruded or molded article) made from a melt processible thermoplastic elastomeric composition comprising:

(a) a continuous phase comprising polyalkylene ether ester amide elastomer; and

(b) a disperse phase comprising cross-linked poly(meth)acrylate rubber. Preferably the shaped article is selected from the group consisting of hoses, gaskets, films, belts, cable jackets, seals, gears and bearings.

The invention is also directed to a process of preparing a shaped article comprising: (a) providing a melt processible thermoplastic elastomeric composition comprising: (i) polyalkylene ether ester amide elastomer; (ii) crosslinkable poly(meth)acrylate rubber; and (iii) a crosslinking system to crosslink the rubber; and (b) forming a shaped article by extruding or molding the melt processible thermoplastic elastomeric composition. Preferably the forming a shaped article is carried out by extrusion or injection molding of the melt processible thermoplastic elastomeric composition.

Preferred polyalkylene ether ester amide elastomers are those made with polyC₂ to C₁₂methylene ether glycols, including copolymers and blends thereof. Preferred are those made with polyethylene ether glycol, polypropylene ether glycol, polytrimethylene ether glycol, polyrtetramethylene ether glycol, poly(1,2-butylene oxide) glycol, polpentaethylene ether glycol, polyhexamethylene ether glycol, polyheptamethylene ether glycol, polyoctamethylene ether glycol, polynonamethylene ether glycol, and polydecamethylene ether glycol. Most preferred is polytrimethylene ether ester amide elastomer.

Preferably the Tₘ of the hard segment is about 150 to about 250° C., preferably at least 200° C., prior to blending.

Preferably, the 1,3-propanediol is derived from a fermentation process using a renewable biological source.

Preferably the crosslinkable poly(meth)acrylate rubber is selected from the group consisting of poly alkyl (meth)acrylate rubber, ethylene/alkyl (meth)acrylate copolymer rubber and polyperfluoroalkylacrylate rubber, and is most preferably an ethylene/alkyl acrylate copolymer rubber where the alkyl group has from 1 to 4 carbons.

Preferably the crosslinking system comprises a peroxide free radical initiator in combination with an organic multiolefinic coagent. The free radical initiator is preferably selected from the group consisting of 2,5-dimethyl-2,5-di-(t-butylperoxy) hexyne-3, t-butyl peroxybenzoate, 2,5-dimethyl-2,5-di-(t-butylperoxy)-2,5-dimethylhexane, dicumyl peroxide, α,α-bis(t-butylperoxy)-2,5-dimethylhexane, and mixtures thereof, and the organic multiolefinic co-agent is preferably selected from the group consisting of diethylene glycol diacrylate, ethylene glycol dimethacrylate, diethylene glycol dimethacrylate, polyethylene glycol dimethacrylate, N,N′-m-phenylene dimaleimide, and triallylisocyanurate.

The curable thermoplastic elastomeric compositions, melt processible thermoplastic elastomeric composition and shaped articles of the invention, as well as the processes of making and using them, have a number of advantages over prior compositions, articles and processes. For instance, the present inventions provide flexible thermoplastic elastomeric compositions, melt processible thermoplastic elastomeric composition and shaped articles which provide excellent resistance to thermal aging and good chemical resistance. In addition, polyamide hard segment blocks are more crystalline than polyester hard segment blocks and use of the more crystalline hard segment with a higher melting temperature extends the upper service temperature range.

### DETAILED DESCRIPTION OF THE INVENTION

Applicants specifically incorporate the entire content of all cited references in this disclosure. Unless stated otherwise, all percentages, parts, ratios, etc., are by weight. Trademarks are shown in upper case. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing and/or claiming this invention, the term “copolymer” is used to refer to polymers containing two or more monomers. The use of the term “terpolymer” and/or “termonomer” means that the copolymer has at least three different comonomers. The term “(meth)acrylic acid” refers to methacrylic acid and/or acrylic acid, inclusively. Likewise, the terms “(meth)acrylate” and “alkyl (meth)acrylate” are used interchangeably herein and mean methacrylate and/or acrylate esters. “Poly(meth)acrylate” means polymers derived from the polymerization of either or a mixture of both corresponding type of monomers. The term “vulcanizate” and the phrase “vulcanizate rubber” as used herein are intended to be generic to the cured or partially cured, cross-linked or cross-linkable rubber as well as curable precursors of cross-linked rubber and as such include elastomers, gum rubbers and so-called soft vulcanizates as commonly recognized in the art. The use of the phrase “organic multiolefinic co-agent” is intended to mean organic co-agents that contain two or more olefinic double bonds. The phrase “rubber phase” and “thermoplastic phase” as used herein refer to and mean the polymeric morphological phases present in the resulting thermoplastic elastomeric blends derived from mixing and dynamic crosslinking of the cross-linkable (meth)acrylate rubber and the polyether ester amide starting materials, according to the method of the present invention. Likewise, the term “elastomer” is used herein to describe not only essentially amorphous materials, but also soft, partially-crystalline materials, often referred to as plastomers, which, in the case of ethylene copolymers, can contain as little as 6.5 mole % comonomer.

The curable thermoplastic elastomer blends according to the present invention involve the mixing of polyether ester amide elastomer and poly(meth)acrylate rubber in the presence of a crosslinking system. The polyalkylene ether ester amide is admixed with a cross-linkable poly(meth)acrylate or ethylene/alkyl (meth)acrylate copolymer rubber. The curable thermoplastic elastomer blend also contains a crosslinking system. More specifically, the crosslinking system preferably involves the combination of a free-radical initiator and an organic multiolefinic co-agent. The use of the free-radical initiator and multiolefinic co-agent results in a curable thermoplastic blend that can be dynamically cross-linked during melt blending and/or melt fabrication. Thus the curable thermoplastic elastomer blend is extruded, injection molded or the like and the free-radical initiator and multiolefinic co-agent acts as a curative agent/system resulting in cross-linking of the rubber, in situ, within the blend.

Preferably the compositions of the invention comprise from about 15 to about 75 wt. % polyalkylene ether ester amide elastomer and from about 25 to about 85 wt. % poly(meth)acrylate rubber.

The resulting dynamically cross-linked product according to the invention will itself be a melt processible thermoplastic elastomer composition. As such, the cross-linked product will be thermoformable and recyclable. Typically the resulting melt processible thermoplastic elastomer will be more thermoplastic than its component rubber phase in the absence of the thermoplastic polyether ester amide phase and will be more elastic than the thermoplastic polyether ester amide phase in the absence of the rubber phase. Furthermore, the resulting melt processible thermoplastic elastomer composition will involve the polyalkylene ether ester amide elastomer being present as a continuous phase while the poly(meth)acrylate or ethylene/alkyl (meth)acrylate copolymer cross-linked rubber will be present as the dispersed phase.

The compositions of this invention contain a crosslinking system to crosslink the rubber. The crosslinking system (and its components) is present in an amount effective crosslink the rubber. Preferably the crosslinking system is selected and is used in amounts sufficient to achieve slow rates of reaction and corresponding desirable high time at maximum G′ rate (and can be quantified for the preferred embodiments as a time at maximum G′ rate of equal to or greater than 3.9 minutes). G′ rate is descried in US 2004/0115450 A1, which is incorporated herein by reference.

Preferably the crosslinking system comprises a peroxide free radical initiator in combination with an organic multiolefinic coagent. Preferably the crosslinking system comprises about 0.1 to about 5 weight %, preferably about 1 to about 5 weight %, most preferably about 1.5 to about 3 weight %, peroxide free radical initiator %, by weight of the rubber. Preferably the coagent is used in an amount of about 0.5 to about 8 weight %, preferably about 2 to about 6 weight %, by weight of the rubber.

Preferred free radical initiators for use in the invention decompose rapidly at the temperature of dynamic cross-linking but not at the melt temperature of mixing of the components. These include, for example, 2,5-dimethyl-2,5-di-(t-butylperoxy) hexyne-3, t-butyl peroxybenzoate, 2,5-dimethyl-2,5-di-(t-butylperoxy)-2,5-dimethylhexane, dicumyl peroxide, α,α-bis (t-butylperoxy)-2,5-dimethylhexane, and the like. Most preferable free-radical initiators are 2,5-dimethyl-2,5-di-(t-butylperoxy) hexyne-3; 2,5-dimethyl-2,5-di-(t-butylperoxy) hexane; and t-butyl peroxybenzoate.

The organic multiolefinic co-agents are preferably organic dienes. The co-agent can be, for example, diethylene glycol diacrylate, diethylene glycol dimethacrylate, N,N′-m-phenylene dimaleimide, triallylisocyanurate, trimethylolpropane trimethacrylate, tetraallyloxyethane, triallyl cyanurate, tetramethylene diacrylate, polyethylene glycol dimethacrylate, and the like. Preferably the co-agents are diethylene glycol diacrylate, diethylene glycol dimethacrylate, N,N′-m-phenylene dimaleimide, and triallylisocyanurate.

The cross-linkable polymeric rubbers useful in the present invention are acrylate-type rubbers. Typically such rubbers are linear copolymers derived by the copolymerization of more than one acrylic acid ester or methacrylic acid ester or mixtures thereof, or are derived by the copolymerization of ethylene and one or more acrylic acid ester or methacrylic acid ester or mixtures thereof. Where the acrylate rubber contains a major amount of ethylene, the acrylate can be little as 6.5 mole %, but for optimally low compression set the acrylate should be above 20 mole %. For purposes of this invention, such poly(meth)acrylates and ethylene/(meth)acrylate copolymers do not require the presence of a functionalized termonomer. However, it is contemplated that the mere presence of small amounts of intentionally added functionalized comonomer for specific end use properties is within the scope of the present invention provided that such functionality does not deleteriously affect the cure rate achieved during dynamic cross-linking by free-radical initiation. Also, it is contemplated that for purposes of this invention certain polyperfluoroalkyl acrylate (FPA) type polymers based on monomers such as 1,1-dihydroperfluoro-n-butyl acrylate and fluorinated copolymers derived from vinylidene fluoride and hexafluoropropylene should be considered equivalent to the acrylate-type rubbers. More preferably the cross-linkable acrylate rubber is a copolymer of ethylene and one or more alkyl esters of acrylic acid, methacrylic acid or mixtures thereof wherein the relative amount of ethylene copolymerized with the acrylic acid esters (i.e., the alkyl acrylate) is less than 80 weight percent and the alkyl acrylate represents greater than 20 weight percent of the copolymer.

Copolymers of ethylene and an acrylate ester are well known. They can be manufactured using two high-pressure free radical processes: tubular processes or autoclave processes. The difference in ethylene/acrylate copolymers made from the two processes is described in, e.g., “High flexibility EMA Made From High Pressure Tubular Process.” Annual Technical Conference—Society of Plastics Engineers (2002), 60^{th} (Vol. 2), 1832-1836.

Of note are copolymers of ethylene and methyl acrylate and copolymers of ethylene and butyl acrylate. Of particular note are copolymers of ethylene and methyl acrylate having from about 25 wt. % to about 40 wt. % of methyl acrylate. Also of particular note are copolymers of ethylene and butyl acrylate having from about 25 wt. % to about 40 wt. % of butyl acrylate. Especially noteworthy are such copolymers prepared by tubular processes. Tubular process ethylene/alkyl acrylate copolymers are commercially available from DuPont under the tradename ELVALOY®AC.

Also of note are copolymers (terpolymers) of ethylene, methyl acrylate, and a second alkyl acrylate (e.g., butyl acrylate). A particular embodiment provides a copolymer derived from copolymerization of ethylene, methyl acrylate comonomer, and n-butyl acrylate comonomer wherein the methyl acrylate comonomer is present in the copolymer from a lower limit of about 5 wt. % to an upper limit which varies linearly from about 45 wt. % when n-butyl acrylate is present at about 41 wt. % to about 47.5 wt. % when n-butyl acrylate is present at about 15 wt. % and wherein the n-butyl acrylate is present in said copolymer from a lower limit of about 15 wt. % when methyl acrylate is present within the range of about 23 to 47.5 wt. % and from a lower limit of about 57 wt. % when methyl acrylate is present at about 5 wt. % and from lower limit that varies linearly between the lower limit at about 5 wt. % of methyl acrylate and the lower limit of about 23 wt. % of methyl acrylate to an upper limit of about 41 wt. % when methyl acrylate is present at about 45 wt. % and to an upper limit of about 80 wt. % when methyl acrylate is present at about 5 wt. % and to an upper limit that varies linearly between about 45 and 5 wt. % methyl acrylate, and the remainder is ethylene.

Similarly, in another embodiment methyl acrylate is present in the copolymer at about 10 to 40 wt. % and n-butyl acrylate is present in the copolymer from a lower limit of about 15 wt. %, when methyl acrylate is present within the range of about 23 to 40 wt. %, and from a lower limit of about 47 wt. %, when methyl acrylate is present at about 10 wt. %, and from a lower limit that varies linearly between the lower limit at about 10 wt. % methyl acrylate and the lower limit at about 23 wt. % methyl acrylate to an upper limit of about 35 wt. %, when methyl acrylate is present at about 40 wt. % and to an upper limit of about 65 wt. %, when methyl acrylate is present at about 10 wt. %, and to an upper limit that varies linearly between about 40 and 10 wt. % methyl acrylate.

Especially notable are terpolymers wherein methyl acrylate is present in the terpolymer at about 15 to 30 wt. % and n-butyl acrylate is present in the copolymer from a lower limit of about 20 wt. %, when methyl acrylate is present within the range of about 27 to 30 wt. %, and from a lower limit of about 45 wt. %, when methyl acrylate is present at about 15 wt. %, and from a lower limit that varies linearly between the lower limit at about 15 wt. % methyl acrylate and the lower limit at about 25 wt. % methyl acrylate to an upper limit of about 45 wt. %, when methyl acrylate is present at about 30 wt. %, and to an upper limit of about 60 wt. %, when methyl acrylate is present at about 15 wt. %, and to an upper limit that varies linearly between about 30 and 15 wt. % methyl acrylate. These terpolymers are described in more detail in U.S. Patent Application 2005-0020775 A1, incorporated by reference herein in its entirety.

Alternatively, the cross-linkable acrylate rubber can comprise a mixture of two or more different ethylene/alkyl acrylate copolymers. A mixture of two or more ethylene/alkyl acrylate copolymers can be used in the present invention in place of a single copolymer as long as the average values for the comonomer content will be within the range indicated above. Particularly useful properties can be obtained when two properly selected ethylene/alkyl acrylate copolymers are used in blends of the present invention. For example, the cross-linkable acrylate rubber may comprise an ethylene/methyl acrylate copolymer mixed with an ethylene copolymer with a different alkyl acrylate (e.g. butyl acrylate). The different polyethylene/alkyl acrylate copolymers may both be prepared using autoclave processes, may both be prepared using tubular processes, or one may be prepared using an autoclave process and the other using a tubular process.

Polytrimethylene ether ester amides useful in this invention are described in U.S. Pat. No. 6,590,065 B1 and U.S. Pat. No. 5,387,651, which are incorporated herein by reference.

The polyamide segment preferably has an average molar mass of at least about 300, more preferably at least about 400. Its average molar mass is preferably up to about 5,000, more preferably up to about 4,000 and most preferably up to about 3,000.

The polytrimethylene ether segment has an average molar mass of at least about 800, more preferably at least about 1,000 and more preferably at least about 1,500. Its average molar mass is preferably up to about 5,000, more preferably up to about 4,000 and most preferably up to about 3,500.

The polytrimethylene ether ester amide preferably comprises 1 up to an average of up to about 60 polyalkylene ether ester amide repeat units. Preferably it averages at least about 5, more preferably at least about 6, polyalkylene ether ester amide repeat units. Preferably it averages up to about 30, more preferably up to about 25, polyalkylene ether ester amide repeat units.

At least 40 weight % of the polyalkylene ether repeat units are polytrimethylene ether repeat units. Preferably at least 50 weight %, more preferably at least about 75 weight %, and most preferably about 85 to 100 weight %, of the polyether glycol used to form the soft segment is polytrimethylene ether glycol.

The weight percent of polyamide segment, also sometimes referred to as hard segment, is preferably at least about 10% and most preferably at least about 15% and is preferably up to about 60%, more preferably up to about 40%, and most preferably up to about 30%. The weight percent of polytrimethylene ether segment, also sometimes referred to as soft segment, is preferably up to about 90%, more preferably up to about 85%, and is preferably at least about 40%, more preferably at least about 60% and most preferably at least about 70%.

The polytrimethylene ether ester amide elastomer comprises polyamide hard segments joined by ester linkages to polytrimethylene ether soft segments and is prepared by reacting carboxyl terminated polyamide or diacid anhydride, diacid chloride or diester acid equivalents thereof and polyether glycol under conditions such that ester linkages are formed. Preferably it is prepared by reacting carboxyl terminated polyamide and polyether glycol comprising at least 50 weight %, more preferably at least 75 weight %, and most preferably about 85 to 100 weight %, polytrimethylene ether glycol.

In one preferred embodiment the carboxyl terminated polyamide is the polycondensation product of lactam, amino-acid or a combination thereof with dicarboxylic acid. Preferably, the carboxyl terminated polyamide is the polycondensation product of C₄-C₁₄ lactam with C₄-C₁₄ dicarboxylic acid. More preferably, the carboxyl terminated polyamide is the polycondensation product of lactam selected from the group consisting of lauryl lactam, caprolactam and undecanolactam, and mixtures thereof, with dicarboxylic acid selected from the group consisting of succinic acid, adipic acid, suberic acid, azelaic acid, sebacic acid, undecanedioic acid, dodecanedioic acid, terephthalic acid, and isophthalic acid, and mixtures thereof. Alternatively, the carboxyl terminated polyamide is the polycondensation product of amino-acid with dicarboxylic acid, preferably C₄-C₁₄ amino-acid and preferably C₄-C₁₄ dicarboxylic acid. More preferably, the carboxyl terminated polyamide is the polycondensation product of amino-acid selected from the group consisting of 11-amino-undecanoic acid and 12-aminododecanoic acid, and mixtures thereof, with dicarboxylic acid selected from the group consisting of succinic acid, adipic acid, suberic acid, azelaic acid, sebacic acid, undecanedioic acid, dodecanedioic acid, terephthalic acid, and isophthalic acid, and mixtures thereof.

In another preferred embodiment, the carboxyl terminated polyamide is the condensation product of a dicarboxylic acid and diamine. Preferably, the carboxyl terminated polyamide is the condensation product of a C₄-C₁₄ alkyl dicarboxylic acid and C₄₋₁₄ diamine. More preferably, the polyamide is selected from the group consisting of nylon 6-6, 6-9, 6-10, 6-12 and 9-6.

Preferably the polytrimethylene ether ester amide has a general structure represented by the following formula (I): 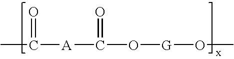
where 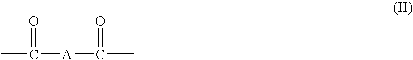
represents a polyamide segment containing terminal carboxyl groups or acid equivalents thereof, and
—O-G-O— (III)
is a polyether segment, and X is 1 up to an average of about 60, and wherein at least 40 weight % of the polyether segments comprise polytrimethylene ether units. (A and G are used to depict portions of the segments which are ascertained from the description of the polytrimethylene ether ester amide and starting materials.)

Preferably the polytrimethylene ether ester amide has the general structure represented by the above formula (I) where (II) represents a polyamide segment containing terminal carboxyl groups or acid equivalents thereof, (III) is a polytrimethylene ether segment, and X is 1 up to an average of about 60.

The melt processed product (e.g., an injected molded product), preferably has a Shore A hardness from about 30 to about 90.

Preferably the Tₘ of the hard segment is about 150 to about 250° C., preferably at least 200° C., prior to blending. Hard segment melt temperature (Tₘ) of the polyalkylene ether ester amide elastomer its blend elastomer is determined using the procedure of the American Society for Testing Materials ASTM D-3418 (1988) using a DuPont DSC Instrument Model 2100 DuPont), according to the manufacturer's instructions. The heating and cooling rates were 10° C. per minute. Polymer samples are heated first, then cooled and heated again. The reported values for Tₘ are for the second heat. Whenever the polymer has exhibits more than one melting peak, the reported Tₘ value is for the major melt peak.

The 1,3-propanediol employed for preparing the polytrimethylene ether ester amides can be obtained by any of the various chemical routes or by biochemical transformation routes. Preferred routes are described in U.S. Pat. Nos. 5,015,789, 5,276,201, 5,284,979, 5,334,778, 5,364,984, 5,364,987, 5,633,362, 5,686,276, 5,821,092, 5,962,745, 6,140,543, 6,232,511, 6,235,948, 6,277,289, 6,297,408, 6,331,264 and 6,342,646, U.S. Pat. Nos. 5,633,362, 5,686,276, and 5,821,092, and U.S. Patent Application Publication Nos. 2004/0225161, 2004/0260125 and 2004/0225162, all of which are incorporated herein by reference in their entireties. The most preferred 1,3-propanediol is prepared by a fermentation process using a renewable biological source. Preferably the 1,3-propanediol used as the reactant or as a component of the reactant will have a purity of greater than about 99% by weight as determined by gas chromatographic analysis.

The actual mixing of components and subsequent dynamic cross-linking can be performed either in a batch mode or a continuous mode using conventional melt blending equipment as generally practiced in the art. Preferably, the process is performed continuously in a melt extruder or injection molding apparatus. The critical consideration is to perform the steps such that one takes advantage of the slow rate of cure at low temperatures, thus, achieving significant mixing and dispersion prior to cross-linking. In this manner the subsequent higher temperature will cross-link the rubber phase after a higher level of dispersion has been accomplished. Using these processes a variety of shaped or molded articles may be produced from the compositions of the invention. Examples of such articles include, but are not restricted to, hoses, gaskets, films, belts, cable jackets, seals, gears and bearings.

The dynamically cross-linked thermoplastic elastomer compositions according to the present invention can be advantageously modified by the addition of various types of fillers, pigments, heat and UV stabilizers, antioxidants, mold release agents, branching agents and the like as generally known in the art. Preferably the melt processible thermoplastic elastomeric composition is stabilized with a combination of polyamide and antioxidant as taught in U.S. Pat. No. 3,896,078, herein incorporated by reference.

Examples of a filler include calcium carbonate, calcium silicate, clay, kaolin, talc, silica, diatomaceous earth, mica powder, asbestos, alumina, barium sulfate, aluminum sulfate, calcium sulfate, basic magnesium carbonate, molybdenum disulfide, graphite, carbon black, carbon fiber and the like. The preferred filler is a carbon black. The amount of a filler should not impair the fluidity and mechanical strengths of the composition. The preferred amount of filler is in the range of 0.1 to 10 wt % of total composition.

### EXAMPLES

The following examples are presented to illustrate in invention and are not intended to be limiting. All percentages, parts, etc. are by weight unless otherwise indicated.

### Example 1

Polytrimethylene ether ester amide was prepared as follows.

Adipic acid (20.0 g) and lauryl lactam (91.8 g) are charged into a flask. The mixture is heated under nitrogen atmosphere at 220° C. for one hour and, then, at 245° C. under nitrogen atmosphere for 2. The reaction mixture is allowed to cool to room temperature and the resulting polyamide is isolated. 15.0 g of this polyamide is charged into a resin kettle followed by polytrimethylene ether glycol, having molecular weight (Mn) of 2360 (43.1 g), ETHANOX 330 antioxidant (90.4 g) and butylstannoic acid catalyst (0.117 g). The reaction mixture is heated for one hour at 210° C. and then one hour at 235° C. under nitrogen atmosphere. The temperature is raised to 245° C. and a vacuum is introduced. The pressure is lowered to 0.01-0.1 mm Hg over 90 minutes. The reaction is continued under vacuum at 245° C. until the torque meter read 90 D.C. milllivolts at 90 rpm. The flask is backfilled with nitrogen, and the polymer is isolated from the kettle and used to make polymer blend.

### Example 2

Polytrimethylene ether ester amide was prepared as follows.

91.2 parts of hypophosphorous acid, 100 parts of water, and 2000 parts of caprolactam are charged to a 10-Liter autoclave equipped with a stirrer. The mixture is heated in a nitrogen atmosphere to 240° C. for 3 hours while maintaining the pressure not to exceed 4 bar. After one hour, the pressure is brought to atmospheric pressure and then 200 parts of polytrimethylene ether glycol, having a molecular weight (Mn) 2000, is added into the autoclave. The mixture is maintained under stirring by continuously reducing the pressure, until a residual pressure of 50 Pa is reached within 5 hours at a temperature of 250° C. The resulting polyether ester amide is extruded from the autoclave and is used to make polymer blend.

### Example 3

Vucanizate compositions are made in a continuous process on a twin screw extruder. Crosslinking chemicals are blended with the ethylene/methyl acrylate copolymer (37 wt. % ethylene/63 wt. % methyl acrylate, melt index ˜15 g/10 min. at 190° C.) rubber at a low enough temperature (˜100° C.) that there is no reaction. The polytrimethylene ether ester amides of Examples 1 or 2 is then dispersed and the temperature gradually increased to ˜250° C. through a series of kneading blocks in the extruder, and the poly(ethylene/methyl acrylate) copolymer is crosslinked during the mixing process using 2,5-dimethyl-2,5-di-(tert-butylperoxy),hexyne-3 (DYBP) and a coagent diethylene glycol dimethacrylate (DEGDM) cure system (dynamic vulcanization). The polytrimethylene ether ester amide becomes the continuous phase and the polyethylene/methyl acrylate copolymer the crosslinked, dispersed rubber phase. The resulting product has rubber-like properties, but can be molded and extruded like a thermoplastic.

Samples are injection molded using barrel temperatures of about 225° C. Plaques (⅛″) are made for compression set testing, and microtensile bars (⅛″) for evaluation of tensile properties.

The curable thermoplastic elastomeric compositions, melt processible thermoplastic elastomeric composition and shaped articles of the invention, as well as the processes of making and using them, have a number of advantages over prior compositions, articles and processes. For instance, the present inventions provide flexible thermoplastic elastomeric compositions, melt processible thermoplastic elastomeric composition and shaped articles, which provide excellent resistance to thermal aging and good chemical resistance. In addition, polyamide hard segment blocks are more crystalline than polyester hard segment blocks and use of the more crystalline hard segment with a higher melting temperature extends the upper service temperature range.

The preferred polytrimethylene ether ester amide elastomer based compositions of the invention have the unique and unexpected combination of lower hardness (greater softness), greater elasticity, and can be used at higher temperatures than the comparable thermoplastic polymers containing other soft segments.

What we claim is:

1. A curable thermoplastic elastomeric composition comprising:
(a) polyalkylene ether ester amide elastomer;
(b) crosslinkable poly(meth)acrylate rubber; and
(c) a crosslinking system to crosslink the rubber.

2. The curable thermoplastic elastomeric composition of claim 1 wherein the compositions of the invention comprise from about 15 to about 75 wt. % polyalkylene ether ester amide elastomer and from about 25 to about 85 wt. % poly(meth)acrylate rubber.

3. The curable thermoplastic elastomeric composition of claim 2 wherein the polyalkylene ether ester amide elastomer comprises polyamide hard segments joined by ester linkages to polyC₂ to C₁₂methylene ether glycols soft segments.

4. The curable thermoplastic elastomeric composition of claim 2 wherein the polyalkylene ether ester amide elastomer comprises polyamide hard segments joined by ester linkages to soft segments prepared from a polyalkylene ether glycol selected from the group consisting of polyethylene ether glycol, polypropylene ether glycol, polytrimethylene ether glycol, polyrtetramethylene ether glycol, poly(1,2-butylene oxide) glycol, polpentaethylene ether glycol, polyhexamethylene ether glycol, polyheptamethylene ether glycol, polyoctamethylene ether glycol, polynonamethylene ether glycol, and polydecamethylene ether glycol.

5. The curable thermoplastic elastomeric composition of claim 2 wherein the polyalkylene ether ester amide elastomer is polytrimethylene ether ester amide elastomer.

6. The curable thermoplastic elastomeric composition of claim 5 wherein the polyalkylene ether ester amide elastomer comprises polyamide repeat units joined by ester linkages to polyalkylene ether repeat units, and wherein at least 50 weight % of the polyalkylene ether repeat units are polytrimethylene ether repeat units.

7. The curable thermoplastic elastomeric composition of claim 5 wherein the polyalkylene ether ester amide elastomer comprises polyamide repeat units joined by ester linkages to polyalkylene ether repeat units, and wherein at least 85 to 100 weight % of the polyalkylene ether repeat units are polytrimethylene ether repeat units.

8. The curable thermoplastic elastomeric composition of claim 1 wherein the crosslinkable poly(meth)acrylate rubber is selected from the group consisting of poly alkyl (meth)acrylate rubber, ethylene/alkyl (meth)acrylate copolymer rubber and polyperfluoroalkylacrylate rubber.

9. The curable thermoplastic elastomeric composition of claim 1 wherein the crosslinking system comprises a peroxide free radical initiator in combination with an organic multiolefinic coagent.

10. A melt processible thermoplastic elastomeric composition comprising:
(a) a continuous phase comprising polyalkylene ether ester amide elastomer; and
(b) crosslinked poly(meth)acrylate rubber disperse phase.

11. The melt processible thermoplastic elastomeric composition of claim 10 wherein the polyalkylene ether ester amide elastomer is polytrimethylene ether ester amide elastomer.

12. The melt processible thermoplastic elastomeric composition of claim 10 wherein the Tm of the hard segment is about 150 to about 250° C. prior to blending.

13. A process for manufacturing a melt processible thermoplastic elastomeric composition comprising the steps:
(a) providing cross-linkable poly(meth)acrylate rubber,
(b) providing crosslinking system in an amount effective to crosslink the poly(meth)acrylate rubber;
(c) providing polyalkylene ether ester amide elastomer;
(d) forming a mixture of the cross-linkable poly(meth)acrylate rubber, the polyalkylene ether ester amide elastomer and the crosslinking system;
(e) cross-linking the cross-linkable poly(meth)acrylate rubber in the mixture using the crosslinking system; and
(f) recovering a melt processible thermoplastic elastomeric composition comprising the polyether ester elastomer as a continuous phase and the crosslinked poly(meth)acrylate rubber as a disperse phase.

14. The process of claim 13 wherein the cross-linking is carried out during extrusion or injection molding of the melt processible thermoplastic elastomeric composition.

15. The process of claim 13 wherein the polyalkylene ether ester amide elastomer is polytrimethylene ether ester amide elastomer.

16. The process of claim 13 wherein the crosslinking system comprises a peroxide free radical initiator in combination with an organic multiolefinic coagent.

17. The process of claim 16 wherein the free radical initiator is selected from the group consisting of 2,5-dimethyl-2,5-di-(t-butylperoxy) hexyne-3, t-butyl peroxybenzoate, 2,5-dimethyl-2,5-di-(t-butylperoxy)-2,5-dimethylhexane, dicumyl peroxide, α,α-bis(t-butylperoxy)-2,5-dimethylhexane, and mixtures thereof, and wherein the organic multiolefinic co-agent is selected from the group consisting of diethylene glycol diacrylate, ethylene glycol dimethacrylate, diethylene glycol dimethacrylate, polyethylene glycol dimethacrylate, N,N′-m-phenylene dimaleimide, and triallylisocyanurate.

18. A shaped article made from a melt processible thermoplastic elastomeric composition comprising:
(a) a continuous phase that comprises polyalkylene ether ester amide elastomer; and
(b) a disperse phase comprising cross-linked poly(meth)acrylate rubber.

19. The shaped article of claim 23 which is made in a mold.

20. The shaped article of claim 23 wherein the shaped article is selected from the group consisting of hoses, gaskets, films, belts, cable jackets, seals, gears and bearings.

21. A process of preparing a shaped article comprising:
(a) providing:
i) polyalkylene ether ester amide;
ii) crosslinkable poly(meth)acrylate rubber; and
iii) a crosslinking system to crosslink the rubber; and
(b) forming a shaped article by extruding or molding the melt processible thermoplastic elastomeric composition.

22. The process of claim 21 wherein the forming a shaped article is carried out by extrusion or injection molding of the melt processible thermoplastic elastomeric composition.
